(19) United States
(12) Patent Application Publication
(10) Pub. No.: US 2016/0230082 A1
(43) Pub. Date: Aug. 11, 2016

(54) Method of Reusing Untreated Produced Water in Hydraulic Fracturing

(71) Applicant: SCHLUMBERGER TECHNOLOGY CORPORATION, Sugar Land, TX (US)

(72) Inventors: Blake McMahon, Sugar Land, TX (US); Bruce Mackay, Sugar Land, TX (US); Andrey Mirakyan, Katy, TX (US)

(21) Appl. No.: 15/023,188

(22) PCT Filed: Jan. 26, 2015
(86) PCT No.: PCT/US15/12864

§ 371 Date: Mar. 18, 2016

Related U.S. Application Data
(60) Provisional application No. 61/931,269, filed on Jan. 24, 2014.

(51) Int. Cl. C09K 8/68; E21B 43/40; C09K 8/90; E21B 43/26

(52) U.S. Cl. CPC C09K 8/685; E21B 43/26; E21B 43/40; C09K 8/90

(57) ABSTRACT

Embodiments herein relate to a method of forming a fluid including controlling the pH of the water, wherein the pH after controlling is 4.0 to 7.5, introducing a polymer comprising guar to the water to form a fluid, introducing a crosslinker comprising zirconium a group 4 metal to the fluid, and observing the viscosity of the fluid, wherein the viscosity is at least 80 cP at 100 s-1 in the first half-hour after introducing the crosslinker. In some embodiments, the water is collected from an oil field services water treatment facility, pond, or truck. Embodiments herein relate to a method of forming a fluid including analyzing water for pH wherein the water comprises a salinity of 300 ppm or greater, controlling the pH of the water, wherein the pH after controlling is 4.5 to 8.0, introducing a polymer to the water to form a fluid, introducing a crosslinker to the fluid, and observing the viscosity, wherein the viscosity is at least 80 cP at 100 s-1 in the first half-hour after introducing the crosslinker is at least 80 cP at 100 s-1 in the first half-hour after introducing the crosslinker.

### PRIORITY CLAIM

This application claims priority to U.S. Provisional Patent Application Ser. No. 61/931,269, entitled, “Method of Reusing Untreated Produced Water in Hydraulic Fracturing,” filed on Jan. 24, 2014. The application is incorporated by reference herein.

### FIELD

Embodiments herein relate to a method of hydraulically fracturing a subterranean formation traversed by a wellbore. Multistage fracturing in long horizontal wellbores may especially benefit from these methods.

### BACKGROUND

Hydraulic fracturing uses pressurized fluids to fracture the subterranean formation. These fluids are tailored for specific physical properties to propagate a fracture or fractures within a formation traversed by a wellbore and to deliver proppant, often sand, into the resulting fractures to prop the fracture open to facilitate hydrocarbon flow. They are often made up in water, where the physical properties of the water are altered and controlled by various chemical products. These fluid physical properties often include viscosity, response to shear stress, and temperature dependent behavior. This fluid tailoring generally requires sophisticated chemical analysis as a key initial step in fluid development. Forming any hydraulic fracturing fluid is an art based in chemistry, material science, mechanical ingenuity, and resource availability. In many regions of the world, developing an effective, low cost chemical composition for the fluid provides significant competitive advantage.

Historically, the development of a fracturing fluid started with fresh water or, when fresh water was not available, water that had been treated to reduce high dissolved solids content, to control the pH, and to remove a wide variety of impurities. Bacteria, fungus, algae, dissolved solids, and high salinity are practically unavoidable water impurities that require costly water treatment before use in a fracturing fluid. When low cost, local freshwater is not available, water is imported from distant lands at great expense. Especially as water resources become more constrained, a method to use more readily available, less pristine, and, often, local available water is needed. An effective, reliable method that uses relatively low cost, commodity chemicals already in use in the oil field service industry is also needed. Factors to consider regarding the economic issues include the following.
Price of fresh water typically $2 to $6/bbl compared to pennies per bbl for municipal or agricultural uses.
Cost of disposal after oil field operations is typically $3 to $11/bbl.
Societal pressures around the scarcity of fresh water exist.

Fracturing is principally done in two modalities: slickwater, using friction reducers to achieve high rate (proppant transport by turbulence, with poor proppant suspension), and gel fracturing, using viscous gelling agents to suspend proppant and to achieve frac width (transport from viscosity, with good proppant suspension). The gelling agents in gels are generally polysaccharides from plants (e.g. guar, cellulose). Occasionally the gelling agent is chemically derivatized prior to use (e.g. HEC, CMHPG). Typically the gel is crosslinked by an inorganic species (e.g. boron, zirconium, titanium), which forms chemical bonds between individual polymer strands to greatly increase viscosity. The most popular gelled fluid currently in use in the industry comprises guar crosslinked with borate at pH above 7. Produced water has posed several challenges to borate crosslinked guar, and the major service companies have made many public statements regarding minimal acceptable water standards for mixwater. The chief barriers to forming durable borate crosslinked guar gels in produced water arise from:
Early crosslinking of the guar from adventitious boron
High temperature gel instability due to presence of Ca, Mg
Competition between Ca & Mg hydroxides (precipitated solids) and buffering agents that stabilize high pH
Fluctuations in any of these concentrations and/or in pH of the mixwater as different PW sources roll through the process stream on location during frac operations
Especially for zirconium based systems, silica and phosphate are generally a problem.

The three major service companies have each publicly listed their criteria for water quality as regards mixwater for borate crosslinked guar.

Water reuse in the United States is on the rise (data from 2011):

TABLE 1
Water Reuse by Formation.

| | Frac Water Used | | | |
|---|---|---|---|---|
| | (million Gallons) | Wells | % Recycled | Comments |
| Bakken | 5.0 | 2281 | 5% | Approximate |
| Barnett | 2.8 | 660 | 7% | |
| Central Rockies | 3.0 | 1743 | 50% | |
| Eagle Ford | 5.1 | 4257 | 10% | |
| Fayetteville | 4.9 | 674 | 7% | |
| Granite Wash | 5.5 | 896 | 20% | |
| Haynesville | 5.6 | 368 | 6% | |
| Marcellus | 5.6 | 1485 | 85% | Averaged |
| | | | | for basin |
| Mississippi Lime | 2.2 | 1046 | 2% | |
| Niobrara | 3.3 | 909 | 6% | |
| Permian | 4.0 | 2073 | 2% | |
| Woodford | 5.5 | 619 | 20% | |
| OVERALL | | | 11% | |

Note that fracturing operations in the Marcellus are conducted almost exclusively using slickwater fracturing, where the simplicity of the chemical systems conferring friction reduction on the water allow relatively easy reuse of highly saline produced waters. The water quality in the Marcellus is very briny, with reported salinities of 160,000 to 280,000 ppm total dissolved solids (TDS). Depending on local and state regulations, operators are under different pressures to control use of freshwater in fracturing and to dispose of their accumulated produced water responsibly. Anecdotally, fresh water can cost operators $2 to $6/bbl and disposal can cost $3 to $11/bbl. With the transition from gas wells (mostly stimulated using slickwater based fluids) to oil and condensate wells (mostly stimulated using gel-based fluids or “hybrid” treatments wherein sections of slickwater are alternated with sections of gel) in the last 2 years, it has become clear that we need to learn how to prepare gelled fluids in waters of high and unpredictable salinity. Salinity of produced water varies tremendously across the US (many of the samples in FIG. 1 were diluted or “cut” 2:1 or 3:1 with fresh by operators before sampling). FIG. 1 is a chart of total dissolved solids for several basins.

Costly CMHPG polymers are employed by some service providers, who are also aggressively treating water using expensive conventional and new techniques such as:
pH-swings to precipitate Ca and Mg, followed by filtration and re-correction
Dissolved air flocculation
Electrocoagulation
Sonication
Ozonolysis
UV treatment.

Many of these offerings generate waste streams. Some are ineffective. All are costly and require additional equipment at a wellsite location, or at least in the process stream at some point. The capital costs can be extremely high. A system that uses a less costly polymer to gel water that requires no treatment beyond its physical delivery to the wellsite is desirable to oil field operators. This is especially true if there exists any regulatory scrutiny, societal pressure, stewardship duty, or social license issues as regards their connate water accumulation and disposal, their fresh water reuse, or both.

### SUMMARY

Embodiments herein relate to a method of forming a fluid including controlling the pH of the water, wherein the pH after controlling is 4.0 to 7.5, introducing a polymer comprising guar to the water to form a fluid, introducing a crosslinker comprising zirconium a group 4 metal to the fluid, and observing the viscosity of the fluid, wherein the viscosity is at least 80 cP at 100 s-1 in the first half-hour after introducing the crosslinker. In some embodiments, the water is collected from an oil field services water treatment facility, pond, or truck. Embodiments herein relate to a method of forming a fluid including analyzing water for pH wherein the water comprises a salinity of 300 ppm or greater, controlling the pH of the water, wherein the pH after controlling is 4.5 to 8.0, introducing a polymer to the water to form a fluid, introducing a crosslinker to the fluid, and observing the viscosity, wherein the viscosity is at least 80 cP at 100 s-1 in the first half-hour after introducing the crosslinker is at least 80 cP at 100 s-1 in the first half-hour after introducing the crosslinker.

### FIGURES

FIG. 1 is a chart of total dissolved solids per shale for several basins.

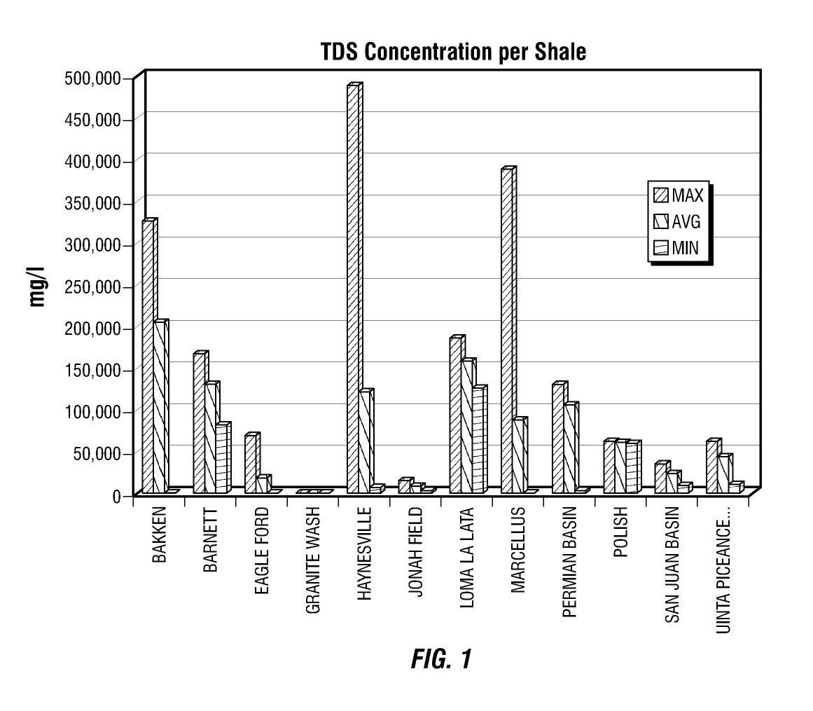

FIG. 2 is a flow chart of the process for one embodiment.

FIG. 3 is a plot of crosslink temperature as a function of lip temperature.

FIG. 4 is a plot of temperature and viscosity as a function of time for varied crosslinker concentration.

FIG. 5 is a plot of temperature and viscosity as a function of time for varied crosslinker concentration.

FIG. 6 is plot of viscosity and time as a function of time for tap water and produced water.

FIG. 7 is a plot of shear rate and viscosity as a function of time for a guar based fluid.

FIG. 8 is a plot of shear rate and viscosity as a function of time for a guar based fluid.

FIG. 9 is a plot of shear rate and viscosity as a function of time for a guar based fluid.

FIG. 10 is a plot of shear rate and viscosity as a function of time for a CMHPG based fluid.

FIG. 11 is a plot of viscosity, shear rate, and temperature as a function of time for a fluid with 45 lb/Mgal CMHPG with 1.0 gpt zirconate crosslinker A.

FIG. 12 is a plot of viscosity, shear rate, and temperature as a function of time for a fluid with 45 lb/Mgal CMHPG with 1.0 gpt zirconate crosslinker A & 0.4 gpt acetic acid solution.

FIG. 13 is a plot of treating pressure and slurry rate per proppant concentration as a function of the total slurry for multiple stages.

FIG. 14 is a plot of viscosity and temperature as a function of time for three fluids with different total dissolved solids concentration.

FIG. 15 is a plot of viscosity and temperature as a function of time for two fluids with 250,000 TDS.

FIG. 16 is a plot of viscosity and temperature as a function of time for two fluids with 43,000 TDS.

FIG. 17 is a plot of viscosity and temperature as a function of time for two fluids with 43,000 TDS.

FIG. 18 is a plot of viscosity and temperature as a function of time for two fluids at different temperature.

FIG. 19 is a plot of viscosity as a function of time for two fluids at different temperature.

FIG. 20 is a plot of viscosity and temperature as a function of time for two fluids with 144,000 TDS.

FIG. 21 is a plot of viscosity and temperature as a function of time for two fluids with 144,000 TDS.

### DESCRIPTION

Embodiments of this invention relate to a method of hydraulically fracturing a well. More specifically, embodiments herein allow for application of gelled fracturing fluids formulated in untreated and undiluted produced (i.e. flowback and/or connate) water of almost any salinity to multistage fracturing in long horizontals. Since these conditions have historically embodied a desirable but extremely difficult challenge, those skilled in the art will recognize that produced water subjected to partial treatment and/or partial dilution that still retains higher-than-acceptable salinity can be employed effectively in hydraulic fracturing operations by application of the invention. Herein we primarily use standard guar, underivatized, as a gelling agent in produced water. The crosslinker is a zirconate salt. Some embodiments use a zironate coordination complex. Some embodiments may use a group 4 metal, including zirconium, titanium, or hafnium. In some cases they may include aluminum. The mixwater is pH corrected to allow for proper hydration of the guar (below 7 to suppress adventitious boron), and crosslinking takes place at low pH. We also demonstrate that we can reliably deploy this type of delayed zirconate fluid across the zones of a long horizontal well.

### Water

Produced water (PW) can be connate water (the product of deep aquifers, commonly “water cut”), or flowback (returned frac fluid, post-injection), or it can be mixtures of these. In some embodiments, the water may include agricultural runoff, municipal waste water, or industrial waste water that has been minimally treated.

In some embodiments, the water will have calcium, magnesium, boron, iron, silica, and various combinations of dissolved solids, at higher concentrations than water that has been historically used for fracturing fluids. The salinity of the water will be higher than are observed in water that has been historically used for fracturing fluids. The initial pH of the water may be higher or lower than water traditionally used for fracturing fluid, another indication that the water may contain a variety of impurities. The boron concentration may be 10 to 700 ppm or higher, the iron content may be 10 to 150 ppm or higher, and the total concentration of calcium and magnesium may be 800 to 24,000 ppm or higher. The silica concentration may be 15 to 200 ppm or higher, and the total dissolved solids may be as high as 340,000 ppm or higher. The total dissolved solid content may vary from 200,000 ppm to 425,000 ppm in some embodiments. Some embodiments may use a mixture of water from a variety of sources. Some embodiments may use one source of water for an entire fracturing job. Some embodiments may dilute connate water with fresh water or water with less undesirable components. Some embodiments may comingle water from various sources mentioned above prior to use. Some embodiments may make use of several different waters in succession.

There are advantages for PW reuse in hydraulic fracturing:
attractiveness of a “closed loop” in completion/production, where water from the producing stratigraphic layer or layers nearby is returned to those layers as a vehicle for proppant in new completions or refracturing or remedial treatments, via the same or a different wellbore in the same general area.
Logistics—in a mature field, connate water may be more near to hand for infill well completion than fresh water
Formation interactions—connate water can be considered as already “optimized” in terms of osmotic effects. Fresh water always returns from the well in a more saline state and at lower volumes than were injected, indicating some retention and dissolution.

Hydraulic fracturing historically accomplished three activities: [1] injecting into the formation a fluid that contains suspended granular material as propping agents; [2] ensuring that some or all of this fluid from the formation and proppant pack can be displaced by reservoir fluids; and [3] producing the well. These three activities are commonly referred to as treating, breaking, and flowing back.

When fracturing is done correctly, the aim of creating a conductive pathway between the wellbore and the formation faces that are exposed during treatment is achieved. In conventional formations, the initial objective was to bypass drilling-induced damage. It was soon noted that there was great benefit in increasing the effective wellbore radius by accessing greater surface area, and thus fracturing volumes and surface areas were increased beyond what is required to bypass damage in the near wellbore. Unconventional and tight formations depend entirely on massive hydraulic fracture volumes to be produced efficiently and economically, which requires large fluid volumes, increased amounts of treating additives, and increased amounts of proppant. In general, the fluid is mostly water with a small amount of some additive included to enhance transport of proppant. There are two general methods for transport: turbulence and viscosification. In turbulence, the pump rates are kept as high as possible to enhance the transport of proppannt into the developing fracture because of high Reynolds number and high local velocities. In viscosification, the viscosity of the fluid is enhanced so that the settling rate of the entrained proppant particles is lowered, via Stokes Law, and the proppant is suspended until the fluid is broken. The E&P industry has come to refer broadly to these two methods as slickwater (high rate abetted by minimal pipe friction) and crosslinked gel (viscosifying agents such as guar and its derivatives, chemically linked together in solution to form an extended crosslinked polymer network with very high viscosity).

The volume of stimulation fluid selected for a well is a critical decision that has a direct impact on production. Slickwater jobs are typically much larger than crosslinked jobs, and there is also a “hybrid” approach that combines slickwater's far-field complexity with crosslinked gel's well-defined proppant pack. In either method, unconventional plays require very large treatment volumes relative to historical work practices in conventional assets. Modern multistage horizontal wells can call for dozens of individual stages, and in pad drilling there may be many different horizontal sections (“laterals”) subtending the same drill site. These factors all lead to multiplication of the volume of water required for stimulation of shales and tight rock, with the result that the modern well requires a few million gallons of water per lateral for completion. The water itself can be classified according to the presence of dissolved material within it. The common aggregate measurement of water quality is “total dissolved solids” (TDS), the dry weight of dissolved material, organic and inorganic, contained in water and usually expressed in parts per million parts by mass. This measurement is often calculated from quantitative water analysis, but it can be measured directly by evaporation and inferred from density or electrical conductivity measurements. Waters can be categorized by their salt content in a hierarchy of increasing salinity—the functional definitions of “potable” are managed by various government agencies in different parts of the world. The general hierarchy of saline waters is:

Fresh—from zero ppm to 10,000 ppm (as defined in the US under 40 CFR Sec 144.3)—it will become clear later in the hierarchy that “fresh” refers to source and not to quality. This water is distinct from groundwater, which resides in porous rock formations below the Earth's surface.
Potable—a subset of Fresh as defined in the US under the US EPA Safe Water Drinking act (defined in EPA Pub.L. 93-523; 42 U.S.C. §300f et seq. Dec. 16, 1974). Generally recommended at 0 to 500 ppm TDS but up to 1000 ppm is accepted in some references.
Saline waters—natural source waters incorporating various amounts of salt. These are broken into subsets according to “Geological Survey Water Supply Paper 1365”, by Winslow and Kister (USGS, 1956), which is a convenient normative reference, as follows:
slightly saline—1000 to 3000 ppm.
moderately saline—3000 to 10,000 ppm
very saline—10,000 to 35,000 ppm
brine—>35,000 ppm

Note that seawater is generally at the boundary of “very saline” and “brine”, whereas “brackish” refers to distastefully salty waters of less than 35,000 ppm salinity (e.g. seawater that has been diluted, surface water that has absorbed minerals as it sits or flows, estuarial waters). Groundwater, by contrast, varies tremendously in TDS and in composition between different aquifers (stratigraphic layers which contain mostly water in contact with rock). Produced water is groundwater that exits a well concomitant with the production of oil and gas. It is sometimes also referred to as “connate water” although geologists reserve this term for water bound to pores within the formation in certain contexts (e.g. interpretation of logs). It can be a component of “flowback” although an exact description of flowback is elusive—in the typical case where fresh water is injected during fracturing operations, it is generally observed that less than 35% of the injected fluid returns to surface when the well is put on production, and that the water is considerably more saline than it was on initial injection. This means that injected fresh water is mixing with connate water and/or becoming saline as it dissolves minerals it contacts prior to flowback. It is therefore very difficult to differentiate between returned injected water and connate water on initial flowback on the basis of chemical analysis because these two effects cannot easily be disentangled.

Produced water from a given oil or gas play falls within a characteristic salinity range. The produced water from the Eagle Ford shale is merely very saline at roughly 19,000 ppm, which is likely acceptable for agricultural use. The produced water from the Permian Basin shows considerable variety depending on its stratigraphic origin, ranging from 80,000 to 220,000 ppm TDS. The produced waters of the Bakken and Marcellus shales are exceedingly salty, with median values well above 200,000 ppm TDS. For example, a thorough review of Marcellus produced water was recently published in Environmental Engineering Science (Vol. 31, No. 9, pgs 514-524 (2014) by Abualfaraj, Gurian, and Olson. From the summary of 35,000 samples, the characteristic ranges can be established. Table 2 includes median ion contents for these plays.

TABLE 2
Chemical components of shale formations.

| | | Shale Play: | | | | Recommended |
|---|---|---|---|---|---|---|
| Parameter | Units | Permian | Bakken | Eagle Ford | Marcellus ¹ | mixwater limits² |
| pH | — | 6.8 | 6.3 | 6.9 | 6.7 | 6 to 10 |
| Alkalinity as | mg/l | 561 | 157 | 300 | 209 | <1600 |
| CaCO3 | | | | | | |
| Chloride | mg/l | 40,403 | 122,703 | 11,574 | 48,721 | 4 to 7% (as KCl) |
| Sulfate | mg/l | 589 | 559 | 139 | 186 | — |
| Calcium | mg/l | 1,598 | 11,666 | 792 | 6,532 | <2,000 |
| Magnesium | mg/l | 236 | 1,254 | 66 | 570 | <200 |
| Sodium | mg/l | 26,609 | 58,422 | 5,893 | 22,285 | — |
| Potassium | mg/l | 435 | 3,860 | 56 | 354 | — |
| Iron | mg/l | 4 | 35 | 15 | 49 | <10 |
| Barium | mg/l | 1 | 16 | 7 | 2,218 | — |
| Strontium | mg/l | 163 | 1,366 | 214 | 1,687 | — |
| Boron | mg/l | 32 | 113 | 44 | 3 | — |
| Total Dissolved | mg/l | 107,402 | 206,403 | 19,118 | 89,287 | “SG < 1.038” |
| Solids (TDS) | | | | | | |
| Total Suspended | mg/l | 1801 | 875 | 1018 | 2113 | — |
| Solids (TSS) | | | | | | |

NOTES:
¹ Marcellus samples are predominantly flowback from freshwater treatments. Median salinities of individual samples from the area can be much higher, up to 320,000 ppm TDS.
²Summary of publicly available limits expressed by the major oilfield service companies.

Water quality directly impacts the effectiveness of chemical additives that are used to control viscosity and/or pipe friction. In the case of slickwater fracturing where friction reducers are the primary functional additive enabling proppant transport, alteration of polymer chemistry has enabled creation of several friction reducers that are highly salt tolerant. In the case of crosslinked gels, the chemistry of the crosslinked polymer system is considerably more complex. The physical chemistry of the industry-standard borate crosslinked guar system underlies the recommended mixwater ion limits published and widely utilized by many oilfield service companies (rightmost column in Table 1). These limits call attention to alkalinity, pH, total salinity, and calcium/magnesium levels, because these water properties can greatly impair crosslinked gel fluid quality. Calcium and magnesium hydroxides precipitate at or above pH 9.25, generating damaging solids and interfering with the control of pH required to deliver a quality crosslinked gel and ensure that a stage proceeds to completion as designed. Alkalinity also interferes with pH control via buffering. Calcium and magnesium ions begin to precipitate as their alkaline metal hydroxides, [M(OH)₂](H₂O)ₓ, as pH rises above about pH 9.25. These precipitation events sequester hydroxide ions, which are clearly critical determinants of the actual fluid pH, as will immediately be recognized by any skilled in the art. The salts themselves are inversely soluble with temperature, so the effect on total hydroxide concentration (and thus on pH) is compounded as the fluid temperature is raised by its passage through the wellbore and onto the formation. The exact timing of these events is difficult to predict. Boron in the mixwater will function as an adventitious crosslinker once the pH is elevated. Too much boron can overcrosslink the system, leading to complete separation of the hydrated gelling agent from the mixwater, total loss of viscosity, and ineffective sand transport. Conversion of produced water into acceptable mixwater under these criteria has therefore required some combination of water treatment to remove hardness and/or boron, and dilution with fresh water.

A few salt-tolerant systems have been proposed that make use of derivatized guar polymers (e.g. hydroxypropyl guar, carboxymethyl guar, or carboxymethylhydroxypropyl guar) and alternate non-borate crosslinkers (see, for example, SPE 94320, SPE 151819, SPE 163824, and SPE 167175 for examples). Some of these examples still require dilution with freshwater, and none employ underivatized guar. A truly salt-tolerant crosslinked gel based on guar provides a viable option for fracturing fluids.

### Polymer

Guar gum is available as a commodity to the oil field services industry. Also known as nonderivatized guar, it is relatively inexpensive. Some embodiments may use CPMHG, HPG, or other modified guar, all of which lead to increased completion cost by virtue of the cost of the chemical derivatization process and subsequent purification steps, in which some guar can be lost. Other embodiments may use a mixture of guar and other polymers. The concentration of the polymer is between 1.2 g/L in upwards of 7.2 g/L (10 ppt and 60 ppt respectively). The hydratable polymer in an embodiment is a high molecular weight water-soluble polysaccharide containing cis-hydroxyl and/or carboxylate groups that can form a complex with the released metal. Without limitation, useful polysaccharides have molecular weights in the range of about 200,000 to about 3,000,000. Galactomannans represent an embodiment of polysaccharides having adjacent cis-hydroxyl groups for the purposes herein. The term galactomannans refers in various aspects to natural occurring polysaccharides derived from various endosperms of seeds. They are primarily composed of D-mannose and D-galactose units. They generally have similar physical properties, such as being soluble in water to form viscous solutions which usually can be gelled (crosslinked) by the addition of inorganic salts such as borax. Examples of some plants producing seeds containing galactomannan gums include tara, huisache, locust bean, palo verde, flame tree, guar bean plant, honey locust, lucerne, Kentucky coffee bean, Japanese pagoda tree, indigo, jenna, rattlehox, clover, fenugreek seeds, and soy bean hulls. The gum is provided in a convenient particulate form. Of these polysaccharides, guar and its derivatives are preferred. These include guar gum, carboxymethyl guar, hydroxyethyl guar, carboxymethylhydroxyethyl guar, hydroxypropyl guar (HPG), carboxymethylhydroxypropyl guar (CMHPG), guar hydroxyalkyltriammonium chloride, and combinations thereof. As a galactomannan, guar gum is a branched copolymer containing a mannose backbone with galactose branches.

Heteropolysaccharides, such as diutan, xanthan, diutan mixture with any other polymers, and scleroglucan may be used as the hydratable polymer. Synthetic polymers such as, but not limited to, polyacrylamide and polyacrylate polymers and copolymers are used typically for high-temperature applications. Nonlimiting examples of suitable viscoelastic surfactants useful for viscosifying some fluids include cationic surfactants, anionic surfactants, zwitterionic surfactants, amphoteric surfactants, nonionic surfactants, and combinations thereof.

The hydratable polymer may be present at any suitable concentration. In various embodiments hereof, the hydratable polymer can be present in an amount of from about 1.2 to less than about 7.2 g/L (10 to 60 pounds per thousand gallons or ppt) of liquid phase, or from about 15 to less than about 40 pounds per thousand gallons, from about 1.8 g/L (15 ppt) to about 4.2 g/L (35 ppt), 1.8 g/L (15 ppt) to about 3 g/L (25 ppt), or even from about 2 g/L (17 ppt) to about 2.6 g/L (22 ppt). Generally, the hydratable polymer can be present in an amount of from about 1.2 g/L (10 ppt) to less than about 6 g/L (50 ppt) of liquid phase, with a lower limit of polymer being no less than about 1.2, 1.32, 1.44, 1.56, 1.68, 1.8, 1.92, 2.04, 2.16 or 2.18 g/L (10, 11, 12, 13, 14, 15, 16, 17, 18, or 19 ppt) of the liquid phase, and the upper limit being less than about 7.2 g/L (60 ppt), no greater than 7.07, 6.47, 5.87, 5.27, 4.67, 4.07, 3.6, 3.47, 3.36, 3.24, 3.12, 3, 2.88, 2.76, 2.64, 2.52, or 2.4 g/L (59, 54, 49, 44, 39, 34, 30, 29, 28, 27, 26, 25, 24, 23, 22, 21, or 20 ppt) of the liquid phase. In some embodiments, the polymers can be present in an amount of about 2.4 g/L (20 ppt).

### Crosslinker

Zirconium containing crosslinkers are commonly used for crosslinking fracturing fluids at pH of 7.0 and higher, but herein, the fluids are deliberately formulated at lower pH. Embodiments herein use zirconium salts including zirconium complexed or formulated with lactate, triethanolamine, carbonate, bicarbonate, glutamate, or any combination thereof.

Titanium and halfnium based crosslinkers will work in embodiments described herein as well as Zr. The concentration of the Group IV metal crosslinker is 8 to 1000 ppm, in some embodiments it is 20 to 2400 ppm. In some embodiments, the concentration of the metal in the crosslinker complex is between 10-100 ppm.

It was established that certain nitrogen- and/or phosphorus-containing carboxylic acids and derivatives can form complexes with the metal. The metal in various embodiments can be a Group 4 metal, such as Zr and Ti. Zirconium (IV) was found to be an effective metal to form complexes with various alpha or beta amino acids and with alpha and beta hydroxyl acids, phosphonic acids and derivatives thereof for the application in crosslinker formulations. These compounds are selected in one embodiment from various alpha or beta amino carboxylic acids, phosphono carboxylic acids, salts and derivatives thereof.

The molar ratio of metal to ligand in the complex can range from 1:1 to 1:10. Preferably the ratio of metal to ligand can range from 1:1 to 1:6. More preferably the ratio of metal to ligand can range from 1:1 to 1:4. Those complexes, including mixtures thereof, can be used to crosslink the hydratable polymers. For a given polymer the crosslinking by metal-amino acid or metal-phosphonic acid complex occurs at substantially higher temperatures than by metal complexes formed only with ligands such as alkanolamines, like triethanolamine, or alpha hydroxy carboxylates, like lactate, that have been used as delay agents.

The following organic acids and their corresponding addition salts are representative non-limiting examples of ligands that can be used for high-temperature crosslinker formulations: alanine, arginine, asparagine, aspartic acid, cysteine, glutamic acid, glutamine, glycine, histidine, isoleucine, leucine, lysine, methionine, phenylalanine, proline, tryptophan, tyrosine, valine, carnitine, ornithine, taurine, citrulline, glutathione, hydroxyproline, and the like. The following organic acids and their salts were found to be ligands for high-temperature crosslinker formulations: D,L-glutamic acid, L-glutamic acid, D-glutamic acid, D,L-aspartic acid, D-aspartic acid, L-aspartic acid, beta-alanine, D,L-alanine, D-alanine, L-alanine, and phosphonoacetic acid.

### pH Control Agent

The pH control agent may comprise reagent-grade or poorer quality sources or mixtures of hydrochloric acid, acetic acid, sodium hydroxide, sodium bicarbonate, formic acid, monopotassium phosphate, dipotassium phosphate, tripotassium phosphate, sodium diacetate, sulfuric acid, sodium bisulfate, potassium hydrogen phthalate, and related electrolytes that act to maintain the acidity or basicity of a solution near a chosen value. The identity and concentration of the pH agent is selected based on the target pH, the composition of the fluid, cost and availability of the agent, and/or final fluid properties targets.

A buffering agent may be employed to buffer the fracturing fluid, i.e., moderate amounts of either a strong base or acid may be added without causing any large change in pH value of the fracturing fluid. In various embodiments, the buffering agent is a combination of: a weak acid and a salt of the weak acid; an acid salt with a normal salt; or two acid salts. Non-limiting examples of suitable buffering agents are: NaH₂PO₄—Na₂HPO₄; sodium carbonate-sodium bicarbonate; sodium bicarbonate, sodium diacetate; and the like. By employing a buffering agent in addition to a hydroxyl ion producing material, a fracturing fluid is provided which is more stable to a wide range of pH values found in local water supplies and to the influence of acidic materials located in formations and the like. In an exemplary embodiment, the pH control agent is varied between about 0.6 percent and about 40 percent by weight of the polysaccharide employed.

Non-limiting examples of hydroxyl ion releasing agent include any soluble or partially soluble hydroxide or carbonate that provides the target pH value in the fracturing fluid to promote borate ion formation and crosslinking with the polysaccharide and polyol. The alkali metal hydroxides, e.g., sodium hydroxide, and carbonates are preferred. Other acceptable materials are calcium hydroxide, magnesium hydroxide, bismuth hydroxide, lead hydroxide, nickel hydroxide, barium hydroxide, strontium hydroxide, and the like. At temperatures above about 79.degree. C. (175° F.), potassium fluoride (KF) can be used to prevent the precipitation of MgO (magnesium oxide) when magnesium hydroxide is used as a hydroxyl ion releasing agent. The amount of the hydroxyl ion releasing agent used in an embodiment is sufficient to yield a pH value in the fracturing fluid of at least about 8.0, at least 8.5, at least about 9.5, and between about 9.5 and about 12.

Fluid embodiments may also include an organoamino compound. Examples of organoamino compounds include tetraethylenepentamine (TEPA), triethylenetetramine, pentaethylenhexamine, triethanolamine (TEA), or any mixtures thereof. Some embodiments may benefit when the organoamino compound is TEPA. Organoamines may be used to adjust (increase) pH, for example. When organoamino compounds are used in fluids, they are incorporated at an amount from about 0.01 weight percent to about 2.0 weight percent based on total liquid phase weight. Preferably, when used, the organoamino compound is incorporated at an amount from about 0.05 weight percent to about 1.0 weight percent based on total liquid phase weight.

As with any fracturing fluid, additional additives may be selected for a specific embodiment. Surfactant and clay control additives may be beneficial for some embodiments. In some embodiments the water itself may have clay stabilizing properties. An antiemulsifier may be selected for some embodiments. In some embodiments, anti-microbial agents are needed. In some embodiments a scale inhibitor may be used, either phosphorous based or non-phosphorous based. Non-phosphorous scale inhibitors are preferred over phosphorous In some embodiments an oxidative or enzymatic breaker may be used to decrease the viscosity of the fluid. Additional information about the components including polymer and crosslinker can be found in U.S. Pat. No. 7,786,050, which is incorporated by reference herein in its entirety.

### Process Considerations

To form the fracturing fluid described herein, several process activities need to occur. The order of the chemical addition and fluid property measurement may be similar to what is described below or it may vary depending on field conditions including available measurement tools and mechanical equipment and chemical availability. In some embodiments, the pH of the source water is adjusted. The polymer is hydrated, the crosslinker is added, and at varied steps additional additives may be introduced. When using water that is not consistent with the existing specifications such as those listed in the Background above, analyzing the water and preparing the fluid composition is appropriate. In order to provide a reliable method to troubleshoot low pH fluids in the field, a testing matrix was developed so that measurable properties of the fracturing fluid could be taken and correlated to the rheological data obtained. This correlation allows the field crew to perform standard measurements in the field and troubleshoot the fluid by changing only one variable, often the crosslinker concentration or pH. The lab measures the following data:
pH
Lip Temperature (fluid begins building viscosity)
Crosslink Temperature (fluid is fully crosslinked, highly viscous)
A pass or fail is assigned to the fluid depending on performance in an HPHT rheometer

In some embodiments, water hardness is also measured and corrected by introducing water softeners. The purpose of this testing is to give the field crew a rapid way to adjust for changing water quality.

The process for one embodiment follows.

Determine the boron concentration
Adjust caustic soda to achieve desired pH; use a water softening agent if excessive caustic soda is needed or if large clumps of insoluble hydroxides form.
If boron concentrations are <100 ppm and hardness passes, consider using a delayed borate crosslinked system with additional small polyol delay agent such as sorbitol, mannitol, gluconate, etc. to avoid surface crosslinking.
If hardness passes, adjust caustic soda to achieve desired pH for a borate system, if excessive caustic soda is needed consider using a low pH system or water softening agent.
If temperature is 270 degF or below and there are high concentrations of Boron, consider adjusting the base fluid pH to 6 and selecting a crosslinked fluid system that does not use boron as the active crosslinker
If temperature is 270 degF or below and there are high concentrations of Calcium and Magnesium, consider adjusting the base fluid pH to 6 selecting a crosslinked fluid system that does not use boron as the active crosslinker.
If pH is in the proper range but hydration is inadequate, lower pH to 6, If hydration is still not adequate, perform a bacterial analysis.
If large amounts of Bacteria are present but TDS is less than 50-60 k consider selecting a crosslinked system based on carboxymethylcellulose gelling agent for wells under 240° F. BHST.

The following chart illustrates a series of test runs with different fluids.

| | | | Surfactant | | | | | | | |
|---|---|---|---|---|---|---|---|---|---|---|
| Gel | | Crosslinker | and clay | | | XL | Lip | XL | | |
| Loading | Crosslinker | Conc | control | Antiemulsifier | pH | pH | Temp | Temp | Pass/Fail | Notes |
| 30 | Zirconate | 1.2 | 1.5 | 0.8 | 5.50 | 5.60 | 115 | 150 | P | Tanks 7-12 |
| 30 | Zirconate | 1.5 | 1.5 | 0.8 | 5.50 | 5.60 | 115 | 145 | P | Tanks 7-12 |
| 30 | Zirconate | 2 | 1.5 | 0.8 | 5.50 | 5.60 | 110 | 130 | F | Over XL |
| | Zirconate | 1.5 | 1.5 | 0.8 | 6.60 | 6.60 | NA | 120 | F | Duo Vis |
| | | | | | | | | | | attempt Fail |
| 30 | Zirconate | 1.5 | 1.5 | 0.8 | 5.68 | 5.70 | 112 | 135 | P | Tanks 13- |
| | | | | | | | | | | 18 |
| 30 | Zirconate | 1.5 | 1.5 | 0.8 | 5.48 | 5.40 | 120 | 145 | p | Tanks 1-6 |
| 30 | Zirconate | 1.5 | 1.5 | 0.8 | 5.48 | 5.43 | 108 | 145 | P | Tanks 1-6 |
| | | | | | | | | | | No change |
| | | | | | | | | | | wStabilizer |
| 30 | Zirconate | 1.5 | 1.5 | 0.8 | 5.06 | 5.10 | 115 | 145 | P | Tanks 24- |
| | | | | | | | | | | 28 |
| 30 | Zirconate | 1.7 | 1.5 | 0.8 | 5.06 | 5.10 | 115 | 135 | P | Tanks 24- |
| | | | | | | | | | | 28 1.5 GPT |
| | | | | | | | | | | Better |
| 30 | Zirconate | 1.5 | 1.5 | 0.8 | 5.04 | 5.10 | 122 | 160 | F | Tanks 19- |
| | | | | | | | | | | 23 Under |
| | | | | | | | | | | XL |
| 30 | Zirconate | 2 | 1.5 | 0.8 | 5.04 | 5.10 | 116 | 135 | P | Tanks 19-23 |

In the chart above, water from different tanks is tested for pH, lip temp, and crosslink temp. Lip and crosslink temperatures are measured after the addition of the crosslinker to the linear gel. The concentration of crosslinker concentration is altered until a pass is obtained. A pass is classified as meeting the client's expectations for fluid performance in an HPHT rheometer. A plot was made of XL temp vs Lip Temp. These two tests are easily performed in the field. On this plot, the fluids that had a lip temp and xl temp that produced a passing fluid were noted by enclosing them in a green “pass” window. In principle, a field engineer could take the plot, test the fluid for lip/xl temp, and if it fell within the window the engineer could be confident the fluid was performing as designed. If the fluid fell outside of the window, they could determine if the fluid was over or under crosslinking and make the appropriate change to the crosslinker concentration only. In some embodiments, the water has a total dissolved solids content of 7% or more and in some embodiments, the water has a total dissolved solids content of 42% or less by weight. In some embodiments, the salinity is 500 to 400,000 ppm and in some embodiments, the salinity is 70,000 ppm to 360,000 ppm.

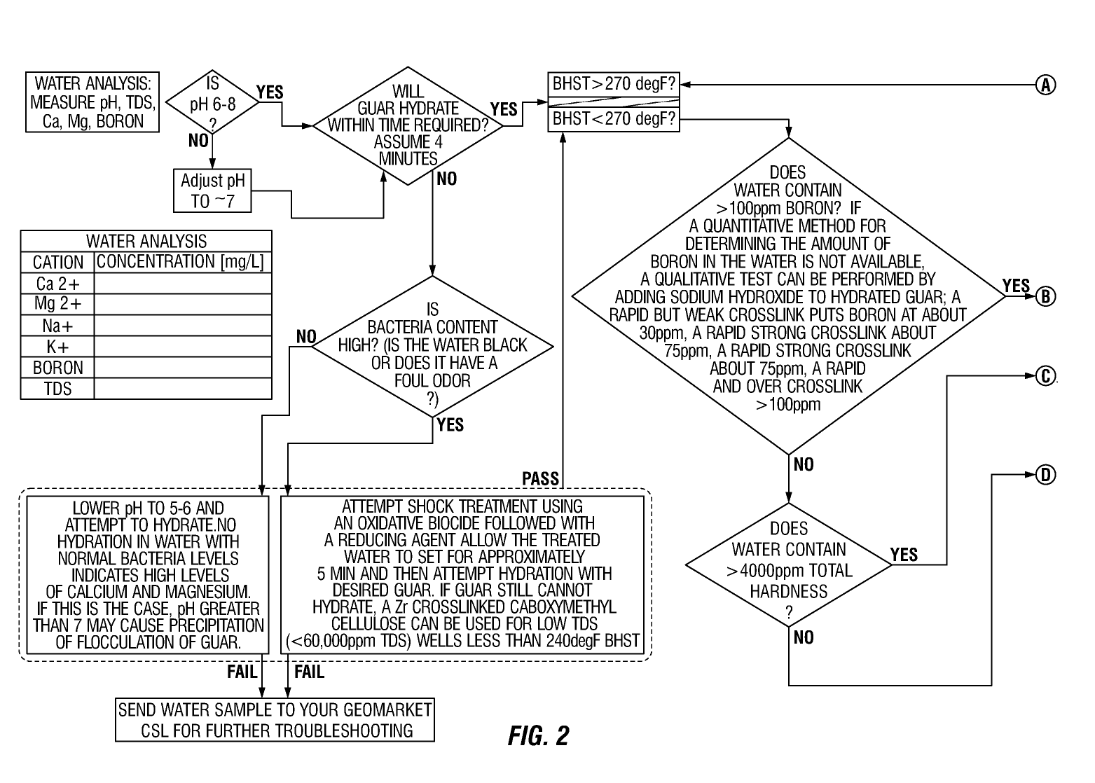

To illustrate an embodiment of this process, FIG. 2 is a flowchart. Initially, pH and other characteristics such as total dissolved solids, calcium, magnesium, and boron concentration may be measured. Adjusting the pH to between 4.5 to 7.0, 5.0 to 6.0, or 4.5 to 8.0, or other target may be appropriate. Testing the time for guar hydration to confirm it is less than 4 minutes occurs. A review of the bottom hole temperature is performed. The water hardness is measured. A delay agent may be added to the fluid. Sodium hydroxide or other pH control agent may be introduced. In some embodiments, forming the fluid and observing the viscosity occur within 500 yards of a wellbore.

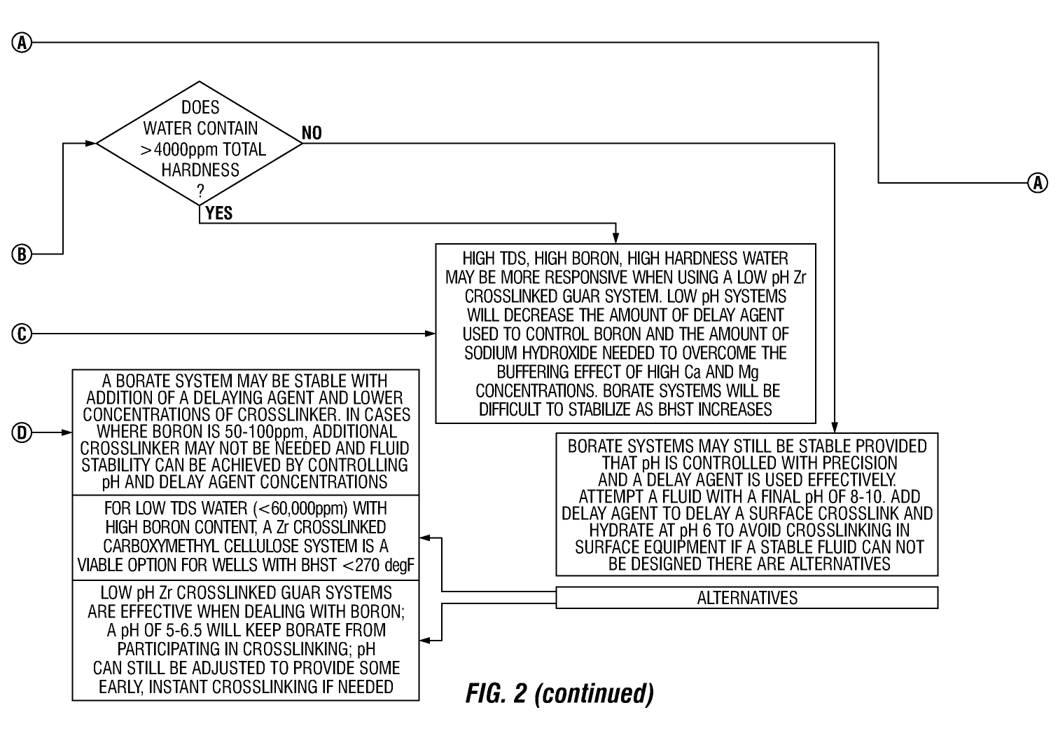

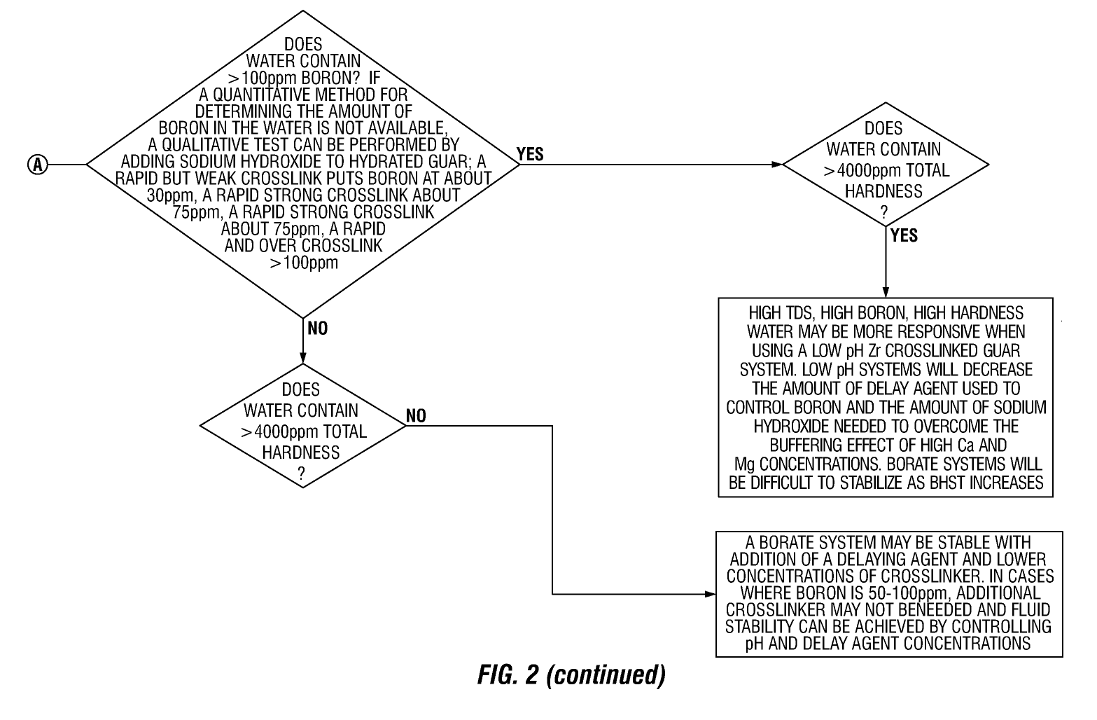

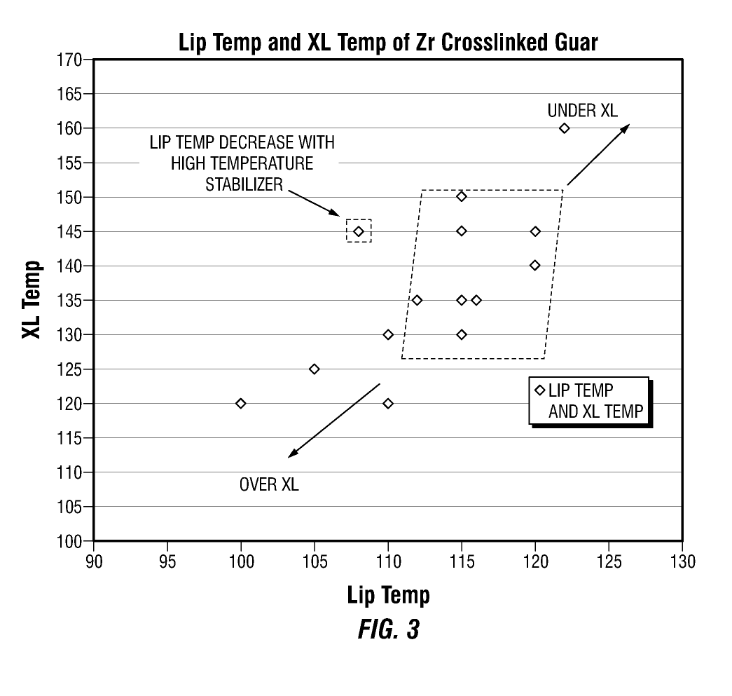

FIG. 3 provides a plot of crosslink temperature as a function of lip temperature. The central section illustrates when a successful fluid composition has been selected. FIG. 4 plots temperature and measured viscosity as a function of time for varied crosslinker concentration to support FIG. 3's analysis. FIG. 5 is another plot of temperature and viscosity as a function of time for varied crosslinker concentration for another formation to also use FIG. 3's analysis. Some embodiments may benefit when the concentration of the metal in the crosslinker complex is between 10-100 ppm. In some embodiments, the formation may have a bottom hole pressure of 900 psi or greater or a temperature of 100° F. or greater or both

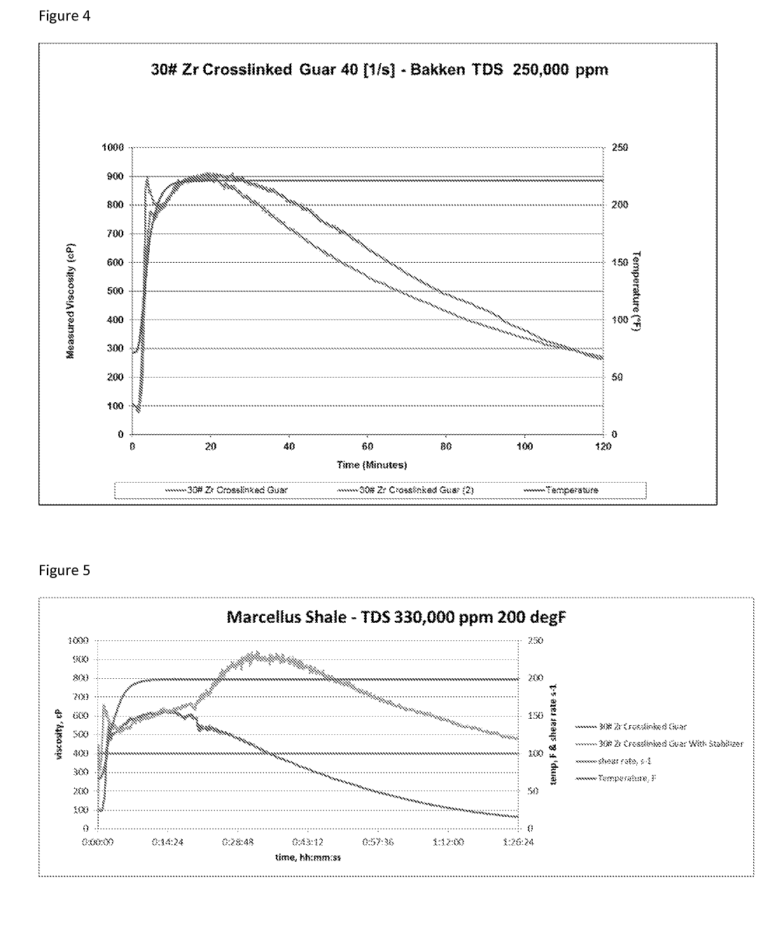

Next, we compare crosslinking guar with Zr-complex in fresh and produced water at low pH. FIG. 6 is plot of viscosity and time as a function of time for tap water and produced water. Guar gum (4.8 g) was dissolved in 1 liter of tap water. 0.8 ml of acetic acid was added to facilitate proper hydration so pH of the hydrated gel is about 5.5. After hydrating the polymer for about 30 minutes, 3 ml of commercially available Zr-lactate crosslinker were added so the resulting Zr content in the fluid was about 30 ppm and pH of the fluid was in the range of 5.4-5.6. Resulting gel was run on a Chandler 5500 rheometer at 100 s-1 shear rate at a slow heatup rate to observe gradual crosslinking.

Guar gum (4.8 g) was dissolved in 1 liter of produced water with ˜36% of dissolved salts by weight. 2 ml of acetic acid was added to facilitate proper hydration so pH of the hydrated gel is about 5.5. After hydrating the polymer for about 30 minutes, 3 ml of commercially available Zr-lactate crosslinker were added so the resulting Zr content in the fluid was about 30 ppm and pH of the fluid was in the range of 5.4-5.6. Resulting gel was run on a Chandler 5500 rheometer at 100 s-1 shear rate at a slow heatup rate to observe gradual crosslinking.

The same heatup profile was used in both cases. The gel prepared from produced water exhibited higher initial viscosity and considerably higher final viscosity (full crosslink) compared to the same fluid formulation prepared in fresh water.

### Example 1

In this example, a field water sample had been pre-treated using an electrocoagulation process in an attempt to remediate the activity of calcium and magnesium ions on the quality of the resulting crosslinked gel. Historical information indicated that the well geometry and bottomhole static temperature of 210 degF should favour use of a crosslinked guar gel based on 25 lbs/Mgal oilfield guar crosslinked with roughly 120 ppm boron at pH 10 to 11 without delaying the onset of crosslinked viscosity. Other surfactant additives aimed at managing interfacial tension and emulsion stability issues were also included as a matter of standard work practice.

### Experimental Methods/Procedures

Water Analysis:
Specific gravity was measured using a Mettler Toledo Densitometer, calibrated to distilled water. Water pH was measured using a Mettler Toledo pH meter, freshly calibrated using standard buffer solutions. Total dissolved solids were determined by gravimetric analysis. Cationic analysis was determined by inductively coupled plasma (ICP) spectroscopy.

Hydration Testing (Fann35):
An R1-B1 rotor/bob combination was used for all experiments, at 300 rpm (511 sec⁻¹).

HPHT Testing (Chandler 5550): Protocol for Fluids Using Guar and Derivatives
1. An R1-B5 rotor/bob combination was used for all experiments.
2. Using the gel sample from the hydration test, the linear gel was transferred into a clean Waring blender and the blender shaft speed was adjusted to create a vortex.
3. After adding the crosslinking additives, the mixture was then mixed for no more than 30 seconds
4. The mixture was then transferred to the HPHT viscometer.
5. HPHT testing was designed per BHST. Shear ramp schedules were based on API RP 39.

### Results and Discussion

### Comprehensive Water Analysis:

The water samples were delivered in three bottles; the samples were clear and did not appear to contain any suspended solids. The densities and pH values of the three samples are shown in Table 1. The results from the water analysis are shown in Table 2 as an average of the three bottles. After testing the three samples were all blended together prior to pilot fluid testing.

### Linear Gel Blending:

Initial testing included blending a linear fluid with standard dry oilfield guar. Upon addition of the guar, precipitation of calcium and magnesium and/or rapid syneresis occurred. The 4 min viscosity of the linear gel was 1 cP. 15% HCl was added to this gel to a pH of 5.6. Viscosity was 20 cP after 12 minutes. The entire batch of sample water was then adjusted to a pH of 5.8 using 15% HCl. Approximately 6 gpt of 15% HCl had to be added implying that there was a strong buffering effect in the 7 pH region. After adjusting the pH, no problems were encountered reaching 80% hydration in 4 minutes.

TABLE 1
Water properties of twelve samples received

| Sample # | Origin | pH | SG |
|---|---|---|---|
| 1 | Bottle 1 | 7.01 | 1.15 |
| 2 | Bottle 2 | 7.00 | 1.151 |
| 3 | Bottle 3 | 7.00 | 1.15 |

TABLE 2
Water analysis

| Analyte/Property | Water treated by electrocoagulation [ppm] |
|---|---|
| Sodium | 68012 |
| Calcium | 14208 |
| Potassium | 4971 |
| Iron | None Detected |
| Magnesium | 677 |
| Boron | 357 |
| Silicon | None Detected |
| Aluminum | None Detected |
| Manganese | None Detected |
| pH | 7.00 |
| SG | 1.15 |
| TDS | 257000 |

### HPHT Testing (Chandler 5550):

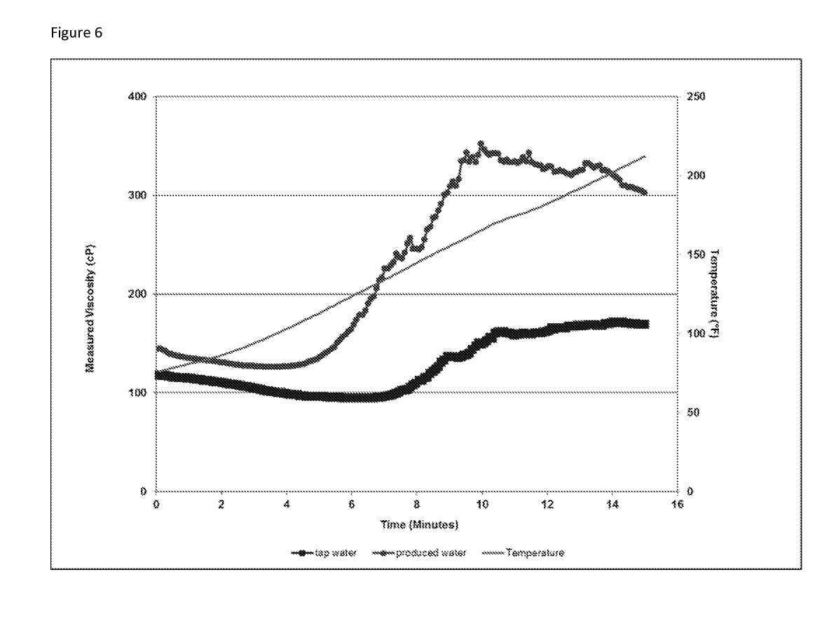

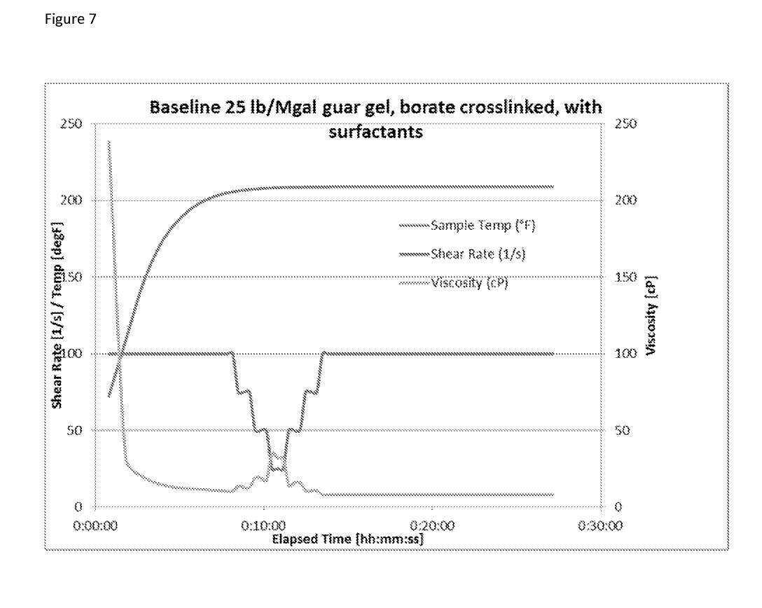

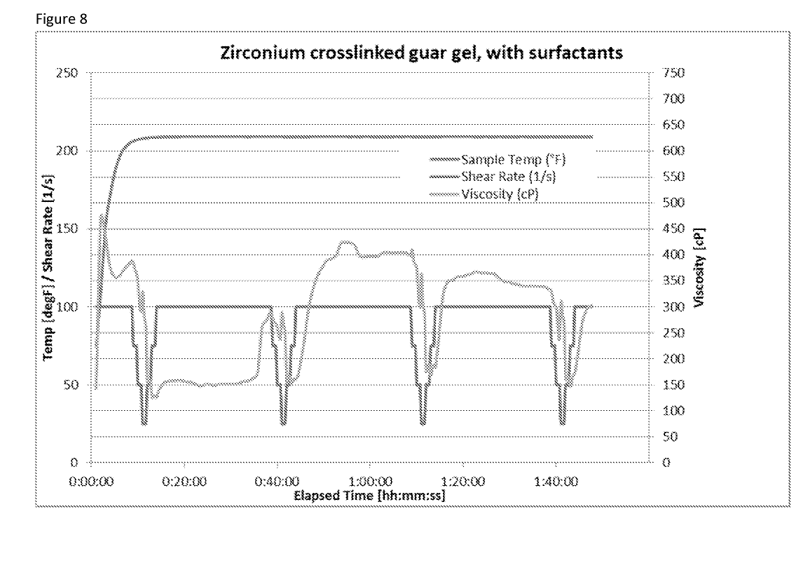

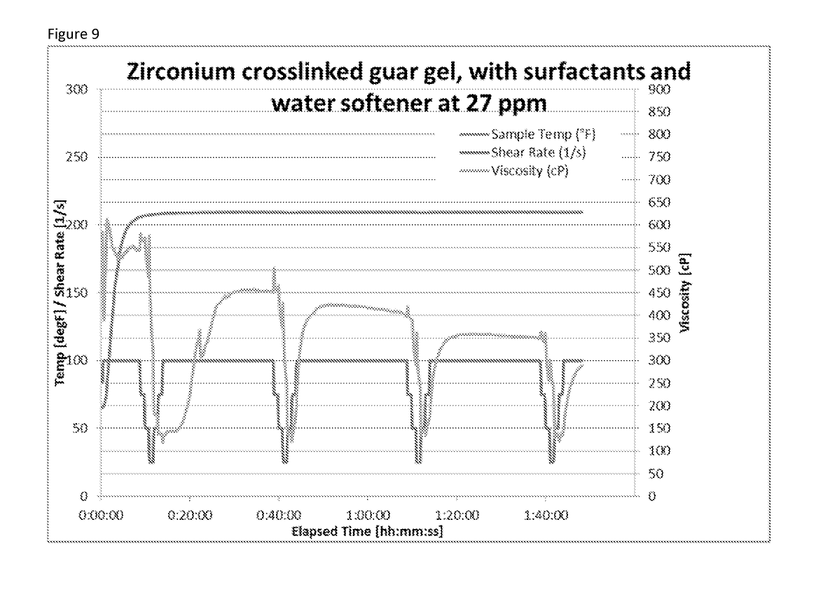

Given the amount of boron in the source water combined with the amount of calcium and magnesium, any borate crosslinking system will be operationally unrealistic, i.e., it would require no less than 30 ppt of small polyol delay agent and 20 gpt of 30% sodium hydroxide solution. Even if excessive chemicals were used, the pH control factor and thus fluid stability has a very narrow tolerance; small increases in pH will lead to surface crosslink and rapid syneresis. In situations where boron has a significant effect on performance, a fluid system that can function at low pH is preferred. For this reason a base line test of the proposed 25 lb/Mgal crosslinked guar gel fluid was performed (FIG. 7); however, all following tests would attempt to optimize the zirconium crosslinked guar (FIGS. 8 and 9) and zirconium crosslinked CMHPG (FIG. 10) systems. Given the limited quantities of sample water, emphasis was placed on the guar system rather than the more costly derivatized CMHPG. FIG. 7 is a baseline test of 25 lb/Mgal guar gel, borate crosslinked, with surfactants, based on historical information from other nearby completions. FIG. 8 provides rheology for zirconate crosslinked guar gel with a crosslink pH of 5.9. FIG. 9 is a plot of zirconium crosslinked guar gel, with surfactants and water softener at 27 ppm with a crosslink pH of 5.8. FIG. 10 is a plot of zirconate crosslinked CMHPG gel, with surfactants, with a crosslink pH of 3.8.

### Conclusions

1. The water itself contains significant amounts of boron. Above pH 7.2, boron is a good crosslinker for guar, but bottom-hole stability of borate crosslinked guar fluids prepared from this water is very poor. Instability is largely due to syneresis from the high concentration of boron. Chemical control of the boron using delay agents would be possible but operationally risky and potentially cost prohibitive. If a solution were devised using borate crosslinked guar and some sort of base activator, the system would be highly sensitive to any variations in water pH and boron content.
2. The water will not allow linear gel hydration without pH adjustment. Even though the pH of the water is 7, the high level of multivalent cations interferes with hydration. The pre-treated water will need to be “pre-treated” with HCl prior to hydration. There appeared to be a significant amount of buffering in the 7 pH region so 6 gpt of 15% HCl would need to be run on the fly into compartment 1 of the hydration unit used to prepare the linear guar gel.
3. CMHPG based fracturing fluids crosslinked with zirconium are also viable options. They will require using CMHPG, a zirconium crosslinker dispersable in aqueous media, and a method of controlling fluid pH. These fluids are very tolerant to high boron concentrations and calcium and magnesium have less of an effect if the fluid pH is maintained at 5 and below.

### Example 2

In this example, a field water sample of very high salinity had received no treatment whatsoever, and water analysis indicated that this water was not acceptable for use as mixwater for a borate-crosslinked guar system without roughly tenfold dilution with fresh water. Total salinity was nearly 260,000 ppm, with substantial calcium, magnesium, and boron present. Again, field data indicated that the well geometry and bottomhole static temperature of 220° F. should favour use of a delayed crosslinked guar gel based on 25 lbs/Mgal oilfield guar crosslinked with roughly 120 ppm boron at pH 10.5 to 11.6 with a delayed crosslinker to enable lower pumping pressures. Other surfactant additives aimed at managing interfacial tension and emulsion stability issues were also included.

### Procedures

Water Analysis:

Specific gravity was measured using a Mettler Toledo Densitometer, calibrated to distilled water. Water pH was measured using a Fisher Scientific AccuMet XL15 pH meter, freshly calibrated using standard buffer solutions. Total dissolved solids were determined by gravimetric analysis. Anionic and cationic analysis was determined by ion chromatography (IC). Cationic analysis was determined by inductively coupled plasma (ICP) spectroscopy.

### Hydration Testing (Fann35):

An R1-B5 rotor/bob combination was used for all experiments, at 300 rpm (511 sec⁻¹).

HPHT Testing (Chandler 5550): protocol for fluids using guar and derivatives
1. An R1-B5 rotor/bob combination was used for all experiments.
2. Using the gel sample from the hydration test, the linear gel was transferred into a clean Waring blender and the blender shaft speed was adjusted to create a vortex.
3. After adding the crosslinking additives, the mixture was then mixed for no more than 30 seconds
4. The mixture was then transferred to the HPHT viscometer.
5. HPHT testing was designed per BHST. Shear ramp schedules were based on API RP 39.

### Results and Discussion

Comprehensive Water Analysis:

Water samples 1-9 as received were opaque and orange-brown, with visible solids present; samples 10-12 as received were colorless and clear. The densities and pH values of the twelve samples are shown in Table 6. The densities and pH of samples 1-9 and 10-12, and were self-consistent and showed minimal variation, thus the assumption was made that the samples 1-9 were all nearly identical for the purpose of blending fluids. The densities and pH of samples 10-12 were self-consistent and showed minimal variation, thus the assumption was made that the samples 10-12 were all nearly identical for fresh water testing purposes. The results from the water analysis are shown in Table 7. The produced water contained 350 ppm of boron and greater than 14,000 ppm of divalent cations.

TABLE 6
Water properties of twelve samples received

| Sample # | Origin | pH | SG |
|---|---|---|---|
| 1 | Client's Produced | 5.37 | 1.154 |
| 2 | Client's Produced | 5.45 | 1.1534 |
| 3 | Client's Produced | 5.47 | 1.1519 |
| 4 | Client's Produced | 5.41 | 1.1542 |
| 5 | Client's Produced | 5.4 | 1.1539 |
| 6 | Client's Produced | 5.41 | 1.1541 |
| 7 | Client's Produced | 5.39 | 1.1539 |
| 8 | Client's Produced | 5.41 | 1.1537 |
| 9 | Client's Produced | 5.41 | 1.1539 |
| 10 | Client Fresh Source C | 7.58 | 1.0008 |
| 11 | Client Fresh Source C | 7.81 | 1.0009 |
| 12 | Client Fresh Source T | 7.99 | 1.0009 |

TABLE 7
Water analysis

| | Client's | | Client Fresh |
|---|---|---|---|
| Analyte/Property | Produced | Client Fresh Source C | Source T |
| Chloride | 168000 | 15 | 19 |
| Sodium | 71000 | 180 | 194 |
| Calcium | 13500 | 90 | 100 |
| Potassium | 5000 | 6 | 6 |
| Ammonium | 2600 | 0 | 0 |
| Magnesium | 1000 | 40 | 50 |
| Boron | 350 | — | — |
| Lithium | 30 | 0 | 0 |
| Sulfate | 0 | 370 | 650 |
| pH | 5.41 | 7.70 | 7.99 |
| SG | 1.1537 | 1.0009 | 1.0009 |
| TDS | 257000 | 1000 | 1000 |

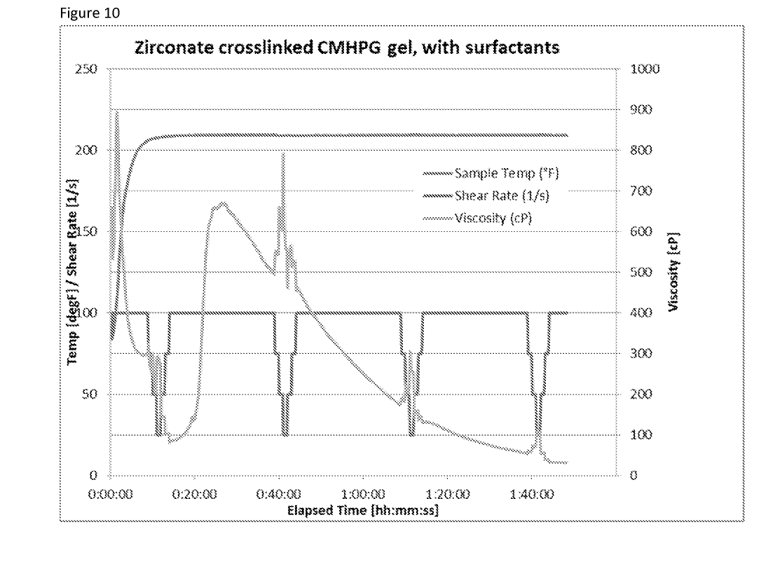

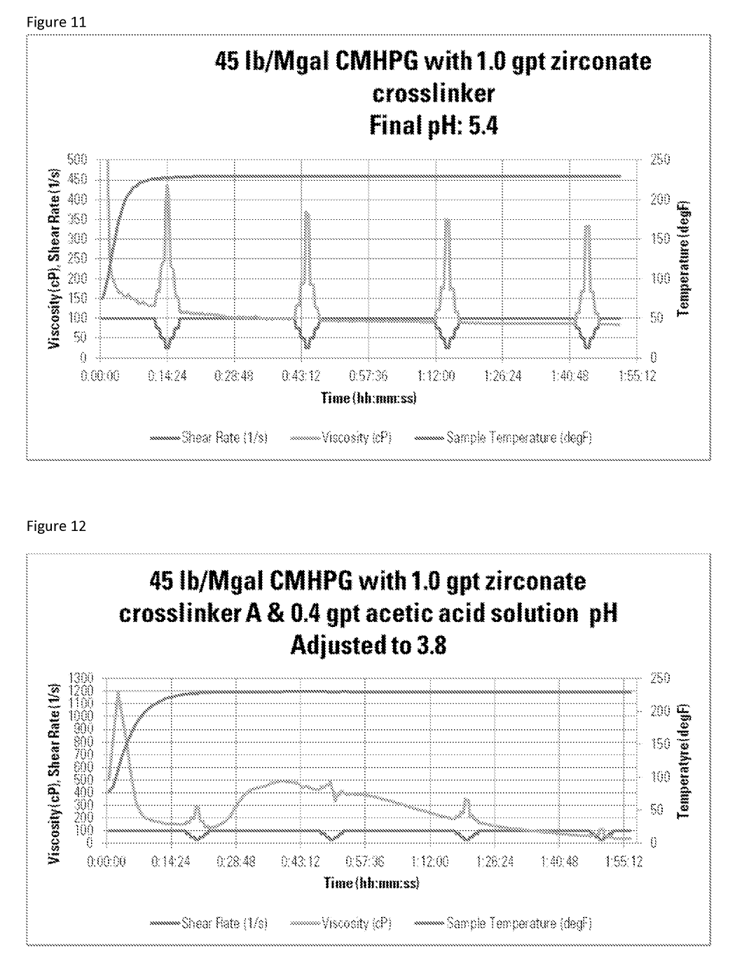

HPHT Testing (Chandler 5550):
Several fluid systems were evaluated, including delayed borate crosslinked guar and viscoelastic surfactant gelling agent fracturing fluids. None of these systems showed acceptable gel strength at BHST.
The zirconate-crosslinked CMHPG fluid system was chosen based on the high level of boron present in the mix water. The following fluid recipes were tested on the Chandler 5550 at the BHST of 230 degF.
   1. 45 lb/Mgal CMHPG with 1.0 gpt zirconate crosslinker A (FIG. 11)
   2. 45 lb/Mgal CMHPG with 1.0 gpt zirconate crosslinker A & 0.4 gpt acetic acid solution (FIG. 12)
      a. The pH of the linear gel was adjusted to 3.8 with L400 before the addition of the crosslinker.

FIG. 11 provides a plot of viscosity, shear rate, and temperature as a function of time for a fluid with 45 lb/Mgal CMHPG with 1.0 gpt of TEA complexed zirconate and FIG. 12 provides rheology for 45 lb/Mgal CMHPG with 1.0 gpt zirconate crosslinker & 0.4 gpt acetic acid solution

### Conclusions

1. The water itself contains significant amounts of boron. Above pH 7.2, boron is a good crosslinker for guar, but bottomhole stability of borate crosslinked guar fluids prepared from this water is very poor. Instability is largely due to syneresis from the high concentration of boron. Chemical control of the boron using delay agents would be possible but extremely expensive (>70 lbs/Mgal small polyol delay agent). If a solution were devised using borate crosslinked guar and some sort of base activator, the system would be highly sensitive to any variations in water pH and boron content.
2. Carboxymethylhydroxypropylguar (CMHPG, a derivatized guar) could be hydrated reliably in the produced water without dilution. A related “dual crosslinker system” using borate and zirconate crosslinkers in concert failed because it requires a high pH regime to control kinetics—at high pH, too much borate was available and fluid stability was very poor. The lower pH Zr-crosslinked CMHPG fluids gave acceptable results, but each successful formulation required using 45 lbs/Mgal of gelling agent and keeping pH low. For one example, the pH was adjusted with acetic acid L400. The system is substantially delayed.

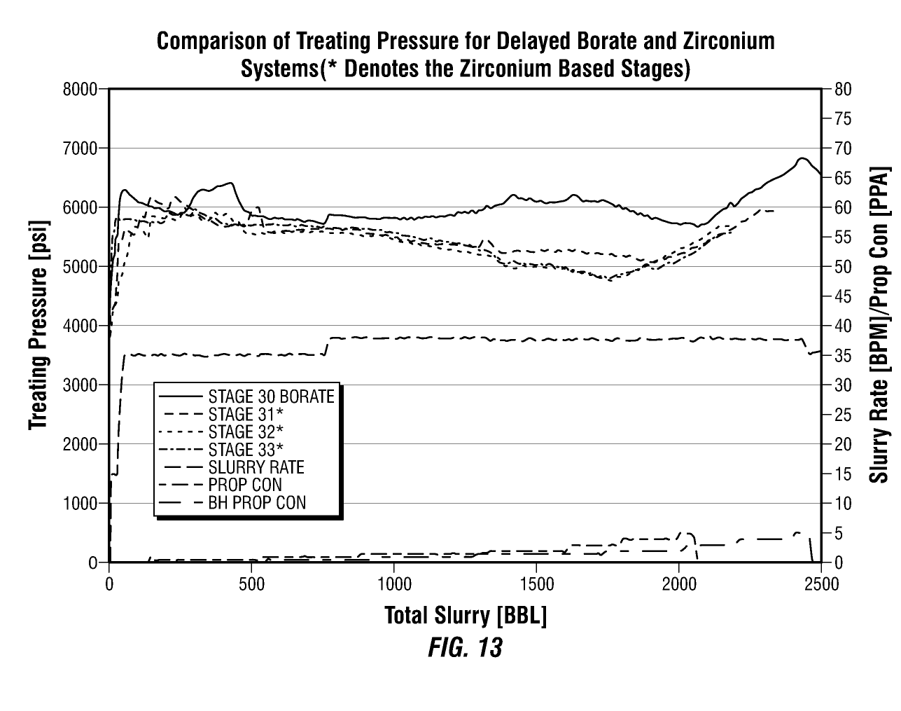

FIG. 13 is a plot of treating pressure and slurry rate per proppant concentration as a function of the total slurry for multiple stages. This plot compares boron crosslinking with zirconium crosslinking. It shows that proppant concentration and pressure were maintained when using zirconium containing crosslinkers.

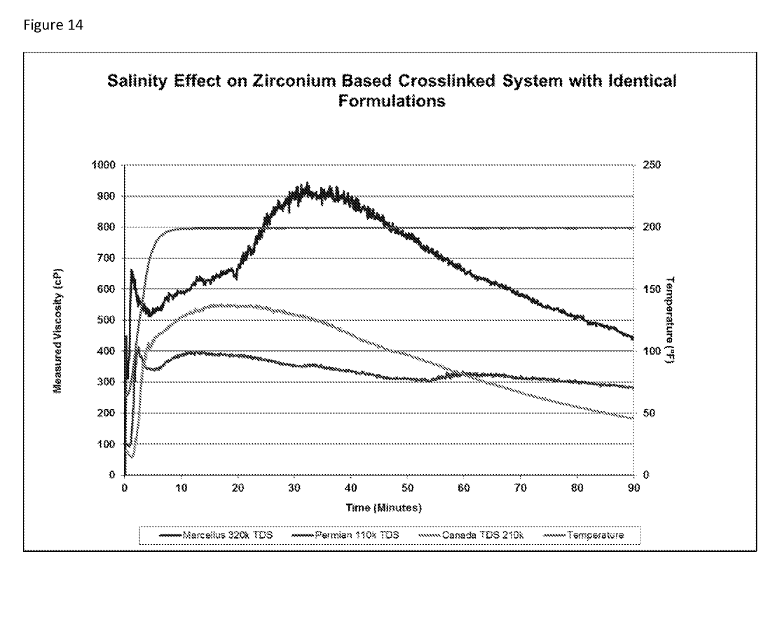

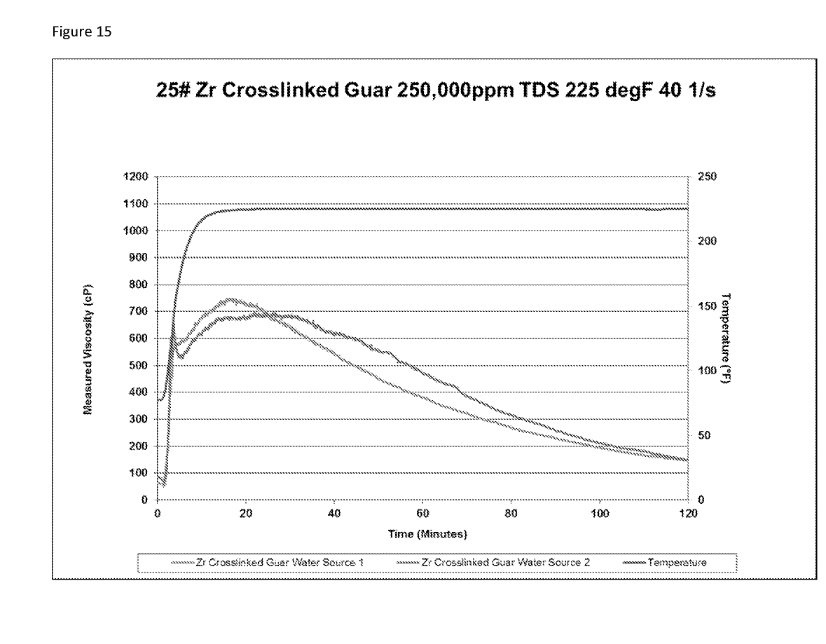

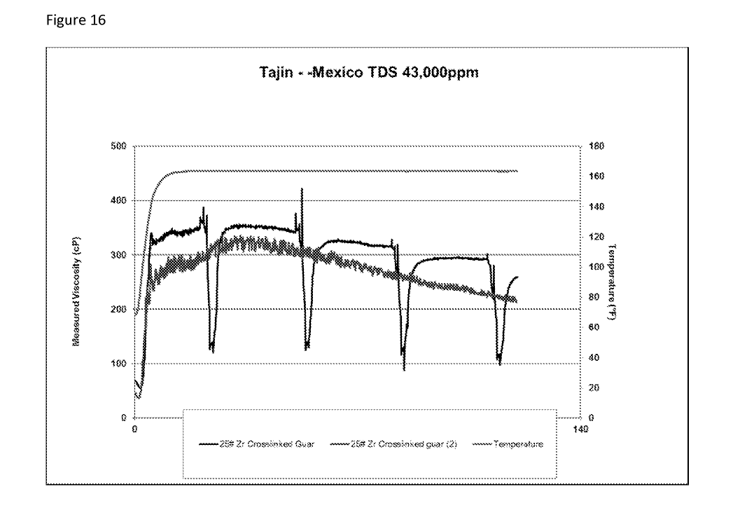

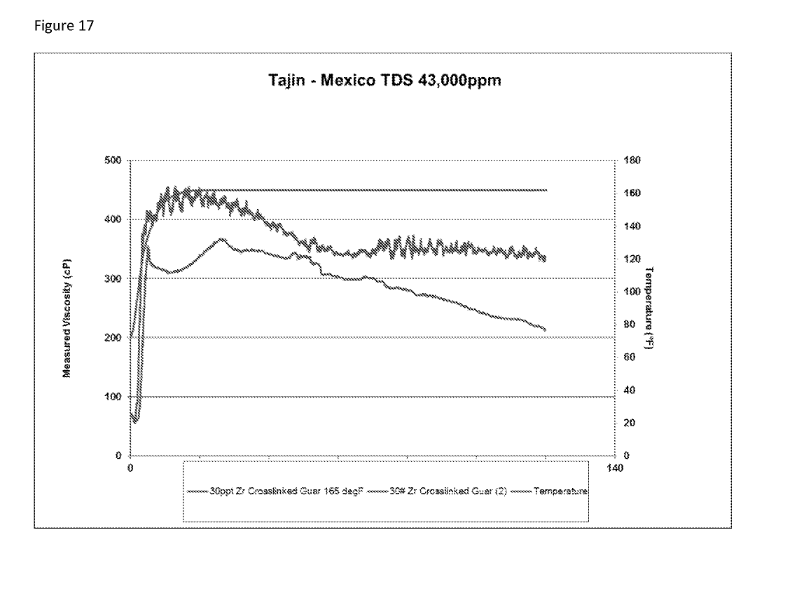

FIG. 14 is a plot of viscosity and temperature as a function of time for three fluids with different total dissolved solids concentration. The mixwaters were from the Marcellus, Permian, and Duvernay formations. Across 110,000, 210,000, and 320,000 TDS, the observed viscosity was effective. Further, the highest salinity water had the most viscous fluid. FIG. 15 is a plot of viscosity and temperature as a function of time for two fluids with 250,000 TDS that demonstrates robustness of the simulated downhole viscosity to operational variation in water quality when water flows from different storage revetments or tanks during a treatment. FIGS. 16 and 17 show that embodiments herein are effective at low TDS and that increase in crosslinker concentration is effective at enhancing viscosity if this is required.

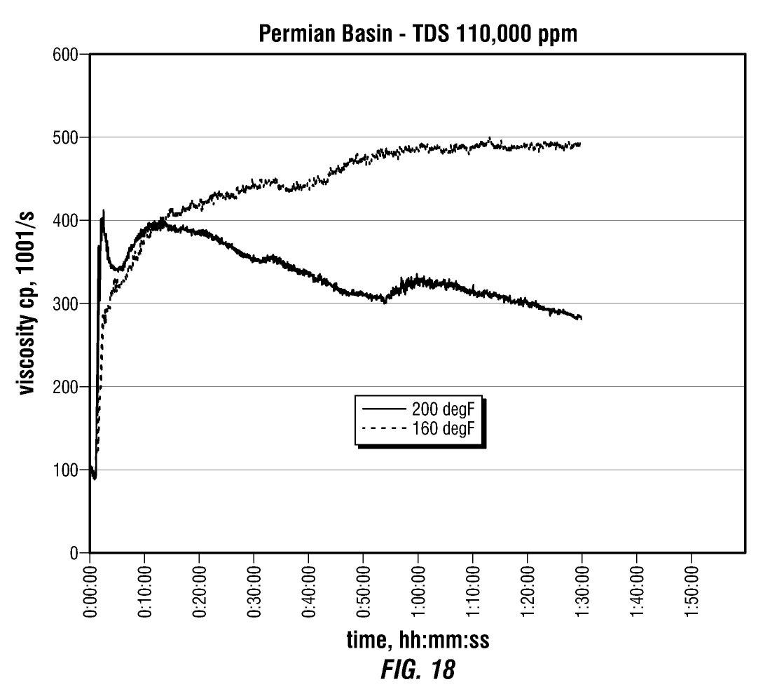

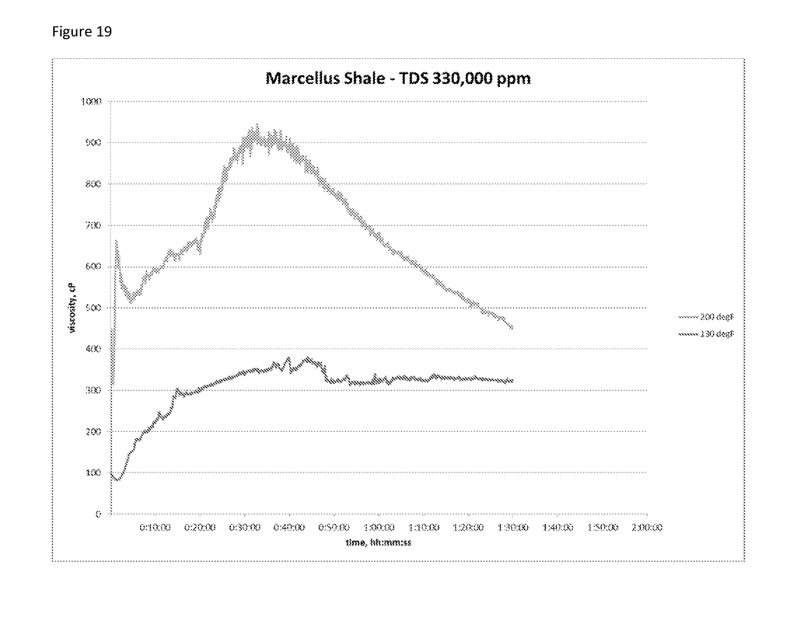

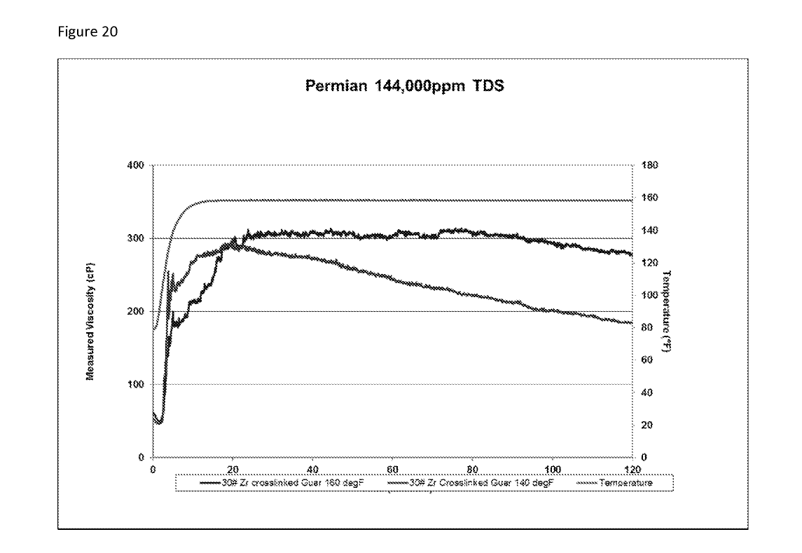

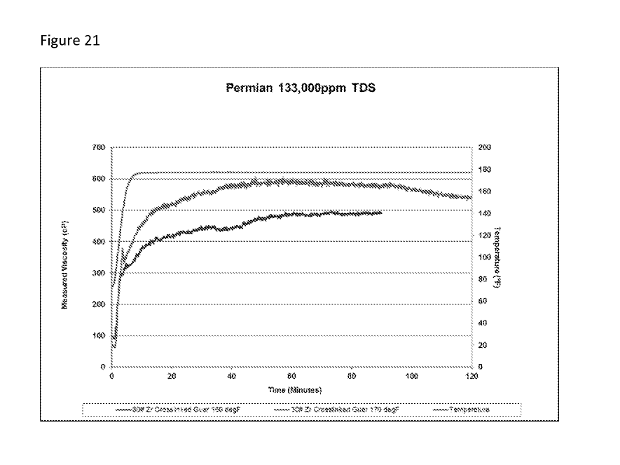

FIGS. 18, 19, 20, and 21 are plots of viscosity and temperature as a function of time for fluids at representative temperatures for the different formations that yielded the mixwater. The comparison of these figures show that across different TDS and different temperature, a fluid using embodiments described herein was effective over time is well suited to use in hydraulic fracturing.

1. A method of forming a fluid, comprising:
controlling the pH of water, wherein the pH after controlling is 4.0 to 7.5;
introducing a polymer comprising guar to the water to form a fluid; and
introducing a crosslinker comprising a group 4 metal to the fluid; and
observing the viscosity of the fluid, wherein the viscosity is at least 80 cP at 1000 in the half-hour after introducing the crosslinker.

2. The method of claim 1, further comprising introducing the fluid to a subterranean formation traversed by a wellbore.

3. The method of claim 1, wherein the water comprises water collected from a subterranean formation traversed by a wellbore wherein the wellbore produces hydrocarbons.

4. The method of claim 1, wherein the water comprises water collected from an oil field services water treatment facility, pond, or truck.

5. The method of claim 1, further comprising introducing additional crosslinker in response to observing the viscosity of the fluid.

6. The method of claim 1, wherein the observing the viscosity comprises comparing a temperature of the fluid before and after crosslinker is introduced.

7. (canceled)

8. The method of claim 1, wherein the observing the viscosity further comprises adding crosslinker to control the viscosity.

9. (canceled)

10. (canceled)

11. The method of claim 1, wherein the crosslinker comprises zirconium lactate, zirconium triethanolamine, zirconium glutamate, or any combination thereof.

12. (canceled)

13. (canceled)

14. The method of claim 1, wherein the controlling the pH comprises introducing a pH control agent.

15. (canceled)

16. A method of forming a fluid, comprising:
analyzing water for pH wherein the water comprises a salinity of 300 ppm or greater;
controlling the pH of the water, wherein the pH after controlling is 4.5 to 8.0;
introducing a polymer to the water to form a fluid;
introducing a crosslinker to the fluid; and
observing the viscosity, wherein the viscosity is at least 80 cP at 100 s-1 in the first half-hour after introducing the crosslinker.

17. The method of claim 16, wherein the polymer is guar, HPG, CMPHG, or a combination thereof.

18. The method of claim 17, wherein the crosslinker comprises zirconium.

19. The method of claim 18, wherein the crosslinker comprises zirconium lactate, zirconium triethanolamine, zirconium glutamate, or any combination thereof.

20. The method of claim 16, wherein the pH after controlling is 5.0 to 6.0.

21. The method of claim 16, wherein the water has a total dissolved solids content of 7% or more.

22. (canceled)

23. (canceled)

24. (canceled)

25. (canceled)

26. The method of claim 16, wherein the salinity is 500 to 400,000 ppm.

27. (canceled)

28. The method of claim 16, wherein the observing the viscosity comprises comparing a temperature of the fluid before and after crosslinker is introduced.

29. The method of claim 28, wherein lip temperature before introducing the crosslinker is ambient to 160° F. and after introducing crosslinker is ambient to 200° F.

30. The method of claim 16, wherein the observing the viscosity comprises using a HPHT rheometer.

31. The method of claim 16, wherein the observing the viscosity further comprises adding crosslinker to control the viscosity.
